(19) United States
(12) Patent Application Publication
(10) Pub. No.: US 2013/0274092 A1
(43) Pub. Date: Oct. 17, 2013

(54) CATALYST COMPOSITION

(71) Applicants: Chung-Cheng LIN, Kaohsiung City (TW); Meng--Hsin Chen, Xinpi Township (TW); Jen-Chun Chiu, Pingtung City (TW); Chih-Hsiang Lin, Taipei City (TW)

(72) Inventors: Chung-Cheng LIN, Kaohsiung City (TW); Meng--Hsin Chen, Xinpi Township (TW); Jen-Chun Chiu, Pingtung City (TW); Chih-Hsiang Lin, Taipei City (TW)

(21) Appl. No.: 13/614,455

(22) Filed: Sep. 13, 2012

(30) Foreign Application Priority Data
Apr. 16, 2012 (TW) 101113421

(51) Int. Cl. C08F 4/46; C08F 4/42

(52) U.S. Cl. 502/170

(57) ABSTRACT

The disclosure provides a catalyst composition, including: a metal or metal compound; and an organic diacid metal salt. The metal includes titanium (Ti), stibium (Sb) or combinations thereof and the metal compound includes antimony oxide (Sb₂O₃) or tetra-n-butoxy titanium (TBT). The catalyst composition includes about 0.3-6 wt % of the metal or metal compound and about 94-99.7 wt % of the organic diacid metal salt.

### CROSS REFERENCE TO RELATED APPLICATIONS

This Application claims priority of Taiwan Patent Application No. 101113421, filed on Apr. 16, 2012, the entirety of which is incorporated by reference herein.

### TECHNICAL FIELD

The present disclosure relates to a catalyst composition, and in particular relates to a catalyst composition used in a polycondensation reaction.

### BACKGROUND

Polyester materials are widely used in industries, such as the electronics, and automobile industries and other fields due to the advantages of good mechanical properties, high chemical stability, and ease of processing and recyclability.

In a polycondensation reaction, product specifications and diversified applications of the polyester materials are improved through a catalyst. Thus, considerable attention has been attracted to the development of the catalyst.

For example, a novel process for the polycondensation reaction using a titanium (Ti) catalyst and phosphate stabilizer is disclosed. The content of the acetaldehyde may be reduced by the phosphate stabilizer.

For example, a novel polymerization catalyst is disclosed. The polymerization catalyst comprises aluminum compounds and phosphorous metal salt compounds.

The disclosure provides a catalyst composition. The reaction rate of the polycondensation reaction may be improved by the catalyst composition, and fabrication time and cost may further be reduced.

### SUMMARY

The disclosure provides a catalyst composition, comprising: a metal or metal compound; and an organic diacid metal salt. The catalyst composition comprises about 0.3-6 wt % of the metal or metal compound and about 94-99.7 wt % of the organic diacid metal salt.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides a catalyst composition which comprises a metal or metal compound and an organic diacid metal salt. The catalyst composition comprises about 0.3-6 wt % of the metal or metal compound and about 94-99.7 wt % of the organic diacid metal salt.

The above-mentioned metal comprises titanium (Ti), stibium (Sb) or combinations thereof.

In one embodiment, antimony oxide (Sb₂O₃) is used as the metal compound.

In another embodiment, tetra-n-butoxy titanium (TBT) is used as the metal compound.

The above-mentioned organic diacid metal salt has the Formula (I) which is a so-called 5-norbornene-2-endo,3-exo-dicarboxylic acid salt,

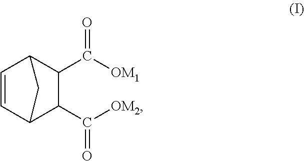

wherein M1 and M2 independently comprise a Group IA element or Group IIA element. The Group IA element comprises lithium (Li), sodium (Na) or potassium (K). The Group IIA element comprises beryllium (Be), magnesium (Mg) or calcium (Ca)

In another embodiment, the organic diacid metal salt has the Formula (II):

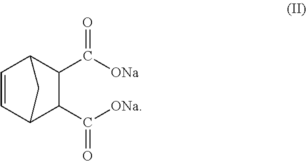

The catalyst composition of the disclosure may be used in a polyester polycondensation reaction. During the polycondensation reaction, the monomers are polymerized by a fusing polymerization method, and the degree of polymerization and molecular weight of the polyester may be improved under high pressure and high vacuum experimental conditions.

In one embodiment, an ester reaction is firstly performed by reacting the aliphatic glycol and the aromatic dicarboxylic acid together, and then a polymerization reaction is performed. During the polycondensation reaction, the catalyst composition of the disclosure is used to accelerate the rate of the polycondensation reaction for forming the polyester.

The aliphatic glycol comprises ethylene glycol (EG), trimethylene glycol, tetramethylene glycol, neopentyl glycol or hexamethylene glycol.

The aromatic dicarboxylic acid comprises terephthalic acid (TPA), isophthalic acid, naphthalenedicarboxylic acid or diphenyldicarboxylic acid.

In another embodiment, the catalyst composition of the disclosure is added into an ester copolymer reaction to accelerate the rate of the reaction.

In the polycondensation reaction, the catalyst composition of the disclosure may disperse well in the polyester materials, and thus the reaction rate of the polycondensation reaction is improved and the fabrication time is further reduced. Additionally, the crystallization rate and crystallinity of the ester material are enhanced by the catalyst composition of the disclosure.

From the above descriptions, the catalyst composition of the disclosure has the following advantages:

(1) the reaction rate of the polycondensation reaction is improved; and

(2) the crystallization rate and crystallinity of the ester material are enhanced.

### EXAMPLE

### Example 1

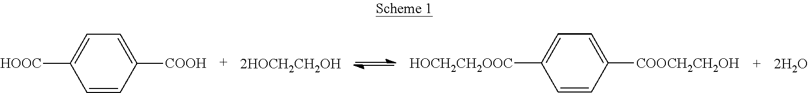

The polyethylene terephthalate (PET) was obtained by an ester reaction and a subsequent polycondensation reaction.

Firstly, the ester reaction of Scheme 1 was performed. The ethyl glycol (EG) and terephthalic acid (TPA) having a mole ration of 1.3 (EG: 210 g (3.38 mole); TPA: 432 g (2.60 mole)) were mixed at 260° C. to perform the eater reaction. The ester reaction was performed until the theoretical amount of water (about 92% esterification rate) had been collected. The temperature of the intermediate product was about 254-256° C.

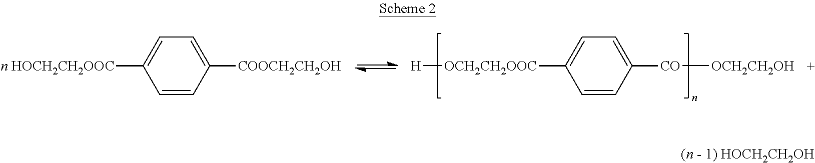

After the easer reaction, the polycondensation reaction of Scheme 2 was performed. During the polycondensation reaction, 300 ppm antimony oxide (Sb₂O₃) and 5000 ppm of Formula (II) were used as the catalyst, 300 ppm triphenyl phosphite (TPP) was used as a thermal stabilizer and 300 ppm Irganox B-561 was used as an antioxidant. The polycondensation reaction was set at a temperature of 275-280° C. under a high vacuum condition. The final product (polyethylene terephthalate (PET)) was obtained until the Torque value was 135 (the intrinsic viscosity (IV) was about 0.6). After breaking the vacuum, the PET product was cooled in water and diced into small pieces. Then, the polyethylene terephthalate (PET) was dried and sealed.

The PET material was analyzed by Differential Scanning Calorimeter (DSC) and an Ostwald viscometer, and the data shows that the melting point (Tm) of PET was 250.4° C., the intrinsic viscosity (IV) of PET was 0.61, the cold crystallization temperature (T_{CC}) of PET was 202.15° C. and the time of polymerization was about 70 minutes.

### Example 2

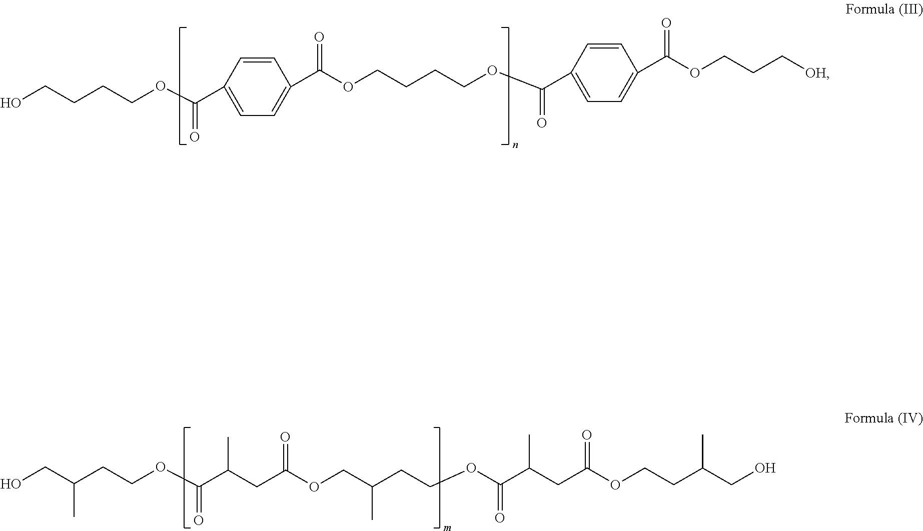

The block ester copolymer was fabricated by the following steps. The PBT Oligomer (Formula (III)) and 2-methyl-1,4-BDO-co-2-methyl succinate (Polyol, Mw=2500˜4000) (Formula (IV)) having a ratio of 40:60 (we %) were added into a reaction tank. 0.3 mol % tetra-n-butoxy titanium (TBT) and 5000 ppm Formula (II) were used as the catalyst, 0.4 wt % of triphenyl phosphite (TPP) was used as a thermal stabilizer and 0.4 wt % of Irganox B-561 was used as an antioxidant, and the catalyst, thermal stabilizer and antioxidant were added into the reaction tank. The polymerization reaction was set at a temperature of 230° C. under a high vacuum condition. The final product (block ester copolymer) was obtained until the Torque value was 140 (the intrinsic viscosity (IV) was about 0.7). After breaking the vacuum, the block ester copolymer was cooled in water and diced into small pieces. Then, the block ester copolymer was dried and sealed.

The block ester copolymer was analyzed and the data shows that the intrinsic viscosity (IV) was 0.7, the tensile strength was 93 kg/cm², elongation was 570%, the Shore-D hardness was 37 and the time of polymerization was about 160 minutes.

### Comparative Example 1

The polyethylene terephthalate (PET) was obtained by an ester reaction and a subsequent polycondensation reaction.

Firstly, the ester reaction was performed. The ethyl glycol (EG) and terephthalic acid (TPA) having a mole ration of 1.3 (EG: 210 g (3.38 mole); TPA: 432 g (2.60 mole)) were mixed at 260° C. to perform the eater reaction. The ester reaction was performed until the theoretical amount of water (about 90% esterification rate) had been collected. The temperature of the intermediate product was about 254-256° C.

After the ester reaction, the polycondensation reaction was performed. During the polycondensation reaction, 300 ppm antimony oxide (Sb₂O₃) was used as a catalyst, 300 ppm triphenyl phosphite (TPP) was used as a thermal stabilizer and 300 ppm Irganox B-561 was used as an antioxidant. The polycondensation reaction was set at a temperature of 275-280° C. under a high vacuum condition. The final product (polyethylene terephthalate (PET)) was obtained until the Torque value was 135 (the intrinsic viscosity (IV) was about 0.6). After breaking the vacuum, the PET product was cooled in water and diced into small pieces. Then, the polyethylene terephthalate (PET) was dried and sealed.

The PET material was analyzed by Differential Scanning Calorimeter (DSC) and an Ostwald viscometer, and the data shows that the melting point (Tm) of PET was 250.4° C., the intrinsic viscosity (IV) of PET was 0.61, the cold crystallization temperature (T_{CC}) of PET was 169.5° C. and the time of polymerization was about 90 minutes.

### Comparative Example 2

The block ester copolymer was fabricated by the following steps. The PBT Oligomer (Formula (III)) and 2-methyl-1,4-BDO-co-2-methyl succinate (Polyol, Mw=2500˜4000) (Formula (IV)) having a ratio of 40:60 (we %) were added into a reaction tank. 0.3 mol % tetra-n-butoxy titanium (TBT) was used as a catalyst, 0.4 wt % of triphenyl phosphite (TPP) was used as a thermal stabilizer and 0.4 wt % of Irganox B-561 was used as an antioxidant, and the catalyst, thermal stabilizer and antioxidant were added into the reaction tank. The polymerization reaction was set at a temperature of 230° C. under a high vacuum condition. The final product (block ester copolymer) was obtained until the Torque value was 140 (the intrinsic viscosity (IV) was about 0.7). After breaking the vacuum, the block ester copolymer was cooled in water and diced into small pieces. Then, the block ester copolymer was dried and sealed.

The block ester copolymer was analyzed and the data shows that the intrinsic viscosity (IV) was 0.7, the tensile strength was 115 kg/cm², elongation was 630%, the Shore-D hardness was 44 and the time of polymerization was about 360 minutes.

Table 1 shows the physical properties of Example 1 and Comparative Example 1. The intrinsic viscosity represents the degree of polymerization (DP). As shown in Table 1, the degree of polymerization of Example 1 was the same as that of Comparative Example 1.

As shown in Table 1, the degree of polymerization of Example 1 was the same as that of Comparative Example 1, but the time of polymerization of Example 1 was obviously shorter than that of Comparative Example 1. Additionally, as shown in Table 1, the cold crystallization temperature (T_{CC}) of Example 1 was higher than that of Comparative Example 1, and this data shows that the crystallization rate of Example 1 was higher than that of Comparative Example 1.

Table 2 shows the physical properties of Example 2 and Comparative Example 2. As shown in Table 2, compared with Comparative Example 2, the time of polymerization of Example 2 was obviously shorter.

TABLE 1

| | | | intrinsic | | | time of | Improved |
|---|---|---|---|---|---|---|---|
| | | | viscosity | T_{CC} | Tₘ | polymerization | efficiency |
| | catalyst | Eg/TPA | (IV) | (° C.) | (° C.) | (min) | (%) |
| Comparative | Sb₂O₃ | 1.3 | 0.61 | 169.5 | 250.4 | 90 | |
| Example 1 | | | | | | | |
| Example 1 | Sb₂O₃/Formula (II) | 1.3 | 0.61 | 202.1 | 250.4 | 70 | 22% |

TABLE 2

| | | hard to soft | intrinsic | tensile | | time of | Improved |
|---|---|---|---|---|---|---|---|
| | | component | viscosity | strength | elongation | polymerization | efficiency |
| | catalyst | ratio (H/S) | (IV) | (kgf/cm²) | (%) | (min) | (%) |
| Comparative | TBT | 60/40 | 0.7 | 115 | 630 | 360 | |
| Example 2 | | | | | | | |
| Example 2 | TBT/ | 60/40 | 0.7 | 164 | 650 | 160 | 56% |
| | Formula | | | | | | |
| | (II) | | | | | | |

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A catalyst composition, comprising:
a metal or metal compound; and
an organic diacid metal salt.

2. The catalyst composition as claimed in claim 1, wherein the metal comprises titanium (Ti), stibium (Sb) or combinations thereof.

3. The catalyst composition as claimed in claim 1, wherein the metal compound comprises antimony oxide (Sb₂O₃) or tetra-n-butoxy titanium (TBT).

4. The catalyst composition as claimed in claim 1, wherein the organic diacid metal salt has the Formula (I): 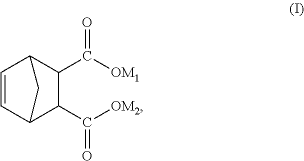
wherein M1 and M2 independently comprise a Group IA element or Group IIA element.

5. The catalyst composition as claimed in claim 4, wherein the Group IA element comprises lithium (Li), sodium (Na) or potassium (K).

6. The catalyst composition as claimed in claim 4, wherein the Group IIA element comprises beryllium (Be), magnesium (Mg) or calcium (Ca).

7. The catalyst composition as claimed in claim 1, wherein the organic diacid metal salt has the Formula (II):

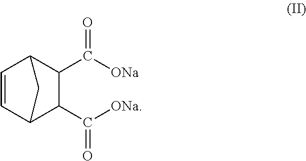

8. The catalyst composition as claimed in claim 1, wherein the catalyst composition comprises about 0.3-6 wt % of the metal or metal compound.

9. The catalyst composition as claimed in claim 1, wherein the catalyst composition comprises about 94-99.7 wt % of the organic diacid metal salt.
